(19) United States
(12) Patent Application Publication
(10) Pub. No.: US 2012/0106871 A1
(43) Pub. Date: May 3, 2012

(54) Combination Grocery/Receptacle Bag with Reinforced Bottom

(76) Inventor: Michelle Goodman, Evanston, IL (US)

(21) Appl. No.: 12/914,754

(22) Filed: Oct. 28, 2010

(51) Int. Cl. B65D 30/00; B31B 1/26; B65D 30/08; B65D 30/20; B65D 33/28; B65D 33/06

(52) U.S. Cl. 383/4; 383/72; 383/12; 383/109; 383/120; 493/243

(57) ABSTRACT

A multi-purpose, two-ply plastic bag is proposed that may be converted from a shopping bag to a garbage bag. The production process is also disclosed.

### FIELD OF THE INVENTION

The present invention relates generally to a plastic bag for carrying items and a method of producing the plastic bag. More specifically, the invention relates to a plastic bag that can be configured as a grocery bag or a garbage can liner and that has a reinforced bottom.

### BACKGROUND OF THE INVENTION

Presently, there are millions of plastic kitchen garbage can liners and billions of plastic shopping and grocery bags in landfills. Some stores and organizations have taken steps toward reducing waste by suggesting methods of reusing plastic bags. Some governmental agencies have adopted legislation to prevent or discourage wide spread use of plastic grocery bags. In June of 2009, a top official in the United Nations called for an outright global ban on single-use carrier bags. Ordinary plastic shopping bags may be used as small garbage can liners, but not for large garbage cans typically found in kitchens and those likely needing the most frequent replacement.

### SUMMARY OF THE INVENTION

The present invention relates to one or more of the following features, elements or combinations thereof:

A multi-purpose, two-ply plastic bag is proposed that can substantially cut down on the number of bags that are discarded in landfills. The bag may be used to carry items home from the store and then may be converted into a tall kitchen garbage can liner. The fused, two-ply construction of the bag adds strength in the area of the bag most likely to tear. Because of the added strength, a lower density material can be used to manufacture the bag, requiring approximately 25%-30% less material than a standard kitchen garbage bag. Additionally, the production process for the bag is proposed. The bags are produced efficiently with square cuts giving very little wasted material.

### BRIEF DESCRIPTION OF THE DRAWINGS

FIG. 1 is a front view of a bag in accordance with one embodiment of the present invention. The bag in FIG. 1 is depicted in its garbage can liner configuration;

FIG. 2 is a front view of the bag depicted in FIG. 1 in its shopping bag configuration;

FIG. 3 is a schematic illustration of the first cutting and folding steps of the production of the bags in FIGS. 1 and 2;

FIG. 4 is a schematic illustration of the production steps following those demonstrated in FIG. 3;

FIG. 5 is a schematic illustration of the production steps following those demonstrated in FIG. 4;

FIGS. 6-13 illustrate a step-by-step description of another embodiment of the present invention.

### DETAILED DESCRIPTION OF EMBODIMENTS OF THE INVENTION

A bag 10 is illustrated in FIG. 1 according to one embodiment of the present invention. In FIG. 1, the bag 10 is depicted in its receptacle configuration. While bag 10 is disclosed for use as a receptacle (or garbage bag) herein, it should be understood that bag 10 is also capable of being a receptacle used for storage or for carrying, as shown in FIG. 2.

Bag 10 illustratively comprises a left side 12, a right side 14, and a front side 16, the side shown. Front side 16 has a top section 18 and a bottom section 20. In this configuration, the bag has two distinct layers, with an identical back side beneath the front side 16 attached at the left side 12 and right side 14 and enclosing a space for storing garbage. The bottom section 20 is twice the thickness of the top section 18 as a result of the manufacturing process described below. This two-ply region strengthens the entire grocery bag and the bottom of the garbage bag liner. Such strengthening of the portion of the garbage bag most likely to tear may save money and natural resources by allowing the use of lower density materials in the bag's production. The bag 10 further comprises a gusset 32 for providing depth.

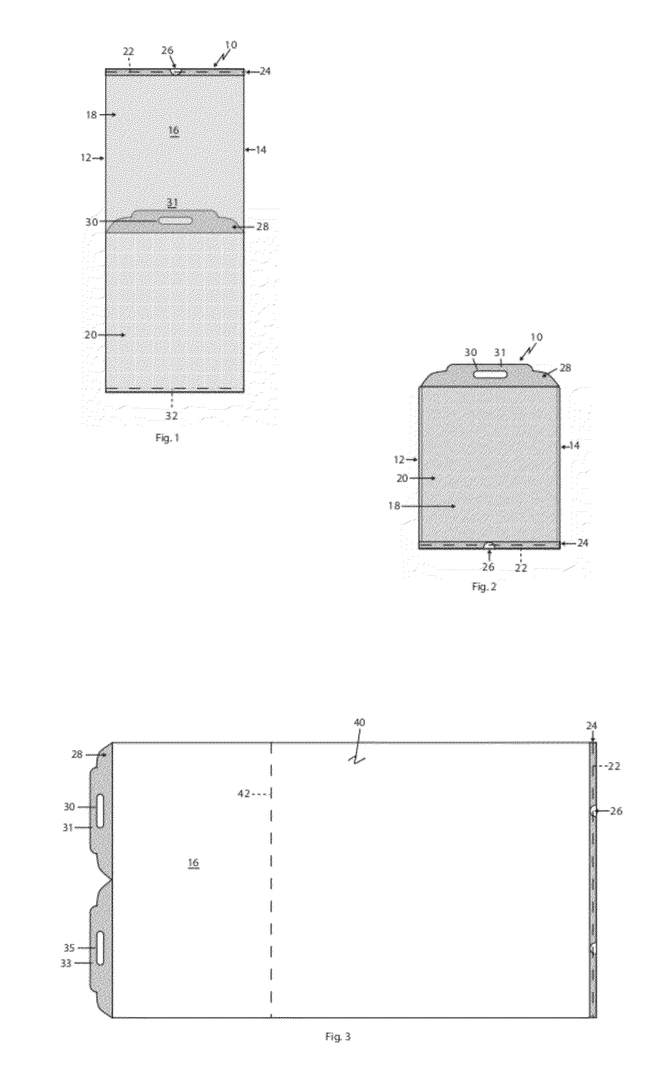

At the top of the front side 16 is an opening surrounded by a drawstring 22 contained in a drawstring compartment 24. The drawstring 22 is pulled from the drawstring hole 26 to tighten and close the opening of the bag. A back side (visible in FIGS. 3-5) of bag 10 is illustratively a mirror image of front side 16, having a drawstring, drawstring compartment, and drawstring hole. It should be understood that the bag can be constructed to be nearly any size, of course.

In the configuration depicted in FIG. 1, a handle section 28 is positioned between top section 18 and bottom section 20. A hole 30 in handle section 28 forms a handle 31 for the alternate grocery or shopping bag configuration of bag 10, as shown in FIG. 2. An identical handle section 33 (visible in FIGS. 3-5) is attached to the inside of the back side of the bag 10. Folding of the top section 18 inside-out and down over the bottom section 20 changes the bag 10 into its alternate shopping bag configuration, shown in FIG. 2. In this arrangement, the handle 31, and identical handle 35 on the back side, are exposed for carrying the bag 10. Here, the bag has four distinct layers, with the back side and front side 16 each folded into double layers enclosing the inside of the bag 10. The shopping bag configuration may be suited for carrying items home from a store, and in this configuration, many such bags can be stored in bunches for easy access by a cashier. Information, such as company logos or advertisements, may also be printed on the inside of the top section 18 of the garbage bag which would comprise the outside of the shopping bag. The bag 10 may also be delivered to a customer at any of a number of locations, i.e. at a store, at a promotional event, or even via mail.

FIGS. 3, 4, and 5 illustrate a schematic process for fabrication of the present invention. It should be understood that the materials comprising plastic bags and the equipment used for production are well known in prior art. However, the present invention contemplates that a plastic additive can be used that assists the plastic in its biodegradability. Or the plastic material itself may be biodegradable. For example, it is contemplated that the plastic material may be a PLA (Polylactic acid) or PHA (polyhydroxyalkanoate) plastic, and 100% biodegradable material.

Turning to FIGS. 3-5, a single sheet of material 40 suitable for forming plastic bags, such as polyethylene, is used. A single long sheet may be used to form many multiple bags, the length equal to the width of multiple bags and determining the number of bags produced. FIGS. 3, 4, and 5 focus on two bags being formed within a single sheet 40.

Beginning with a sheet of material, to obtain the stage depicted in FIG. 3, a segment on one end may be folded over and fused to form and reinforce the handle section 28. A handle shape with holes can then be cut in the handle section to form the handles 31, 35. Additional holes can then be cut in the opposite end, forming the drawstring holes 26. During formation of the bag, a drawstring 22 is laid over the drawstring holes 26 along the length of the sheet, and the end is folded over at the middle of the drawstring holes 26. The folded-over segment may then be fused to embed drawstring 22 in a drawstring compartment 24.

Other embodiments for the handles are also contemplated. For example, the drawstring end could be a tie type end or just a straight end intended for use with twist ties. Alternatively, the handles could be integral with the bag 10 material.

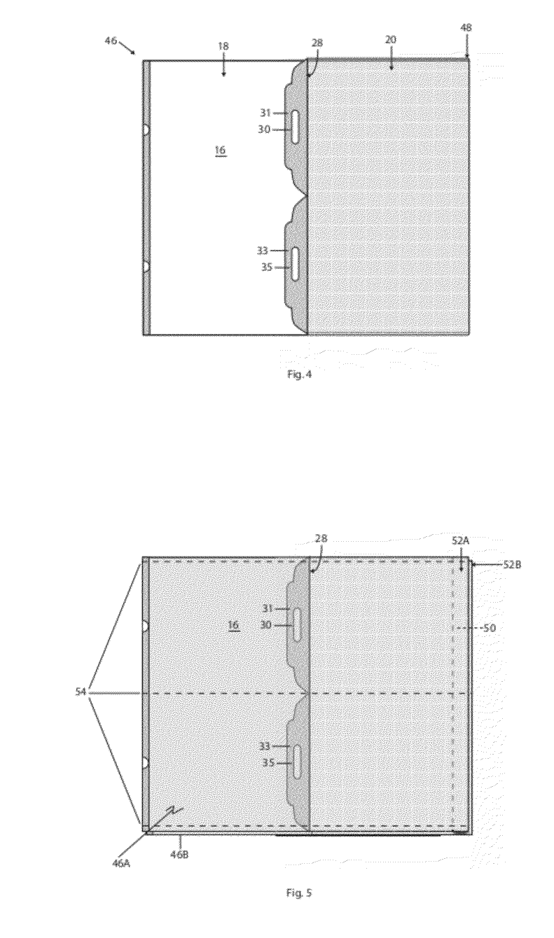

A dotted line 42 in FIG. 3 denotes the fold line to fold the side with the drawstring 22 over the side with the handle 31. The dotted line 42 is illustratively one-third of the way from the handle section 28 to the drawstring 22, although anywhere over one-half and below three-quarters of this dimension is plausible. Folding over two-thirds of the sheet 40 gives an overlay of about one-half of the new sheet 46, as illustrated in FIG. 4. The overlapped portion from the bottom of the handle section 28 to the folded edge of the sheet 48 is illustratively fused, giving a two-ply region of double thickness—the bottom section 20. The sheet 46 also comprises a top section 18, and acts as one side, front 16 or back, of all bags being produced identical to the bag 10 illustrated in FIG. 1.

Referring to FIG. 5, two identical sheets 46A and 46B are illustratively placed one on top of the other such that handles 31, 35 are each enclosed by the rest of the material. The two sheets are fused together along the bottom edge. The dotted line 50 denotes a fold line where the portion 52A is folded underneath 46A and between 46A and 46B. An identical portion 52B of sheet 46B can be folded between the two layers in the same manner. Fusing of the edge of 52A to the edge of 52B creates the gusset 32, visible in FIG. 1. The connected sheets 46A and 46B are then fused along the dotted lines 54, and the fused edges of each resulting segment may then be cut and separated to create the left and right sides 12 and 14 illustrated in FIG. 1 of each bag. This step may be adjusted with small segments of the bags left uncut to link them together for use by a cashier. The linked bags may be “Z” or accordion folded to form bundles for storing and shipping. The production process described herein has an advantage of using right angle cuts, yielding little wasted material.

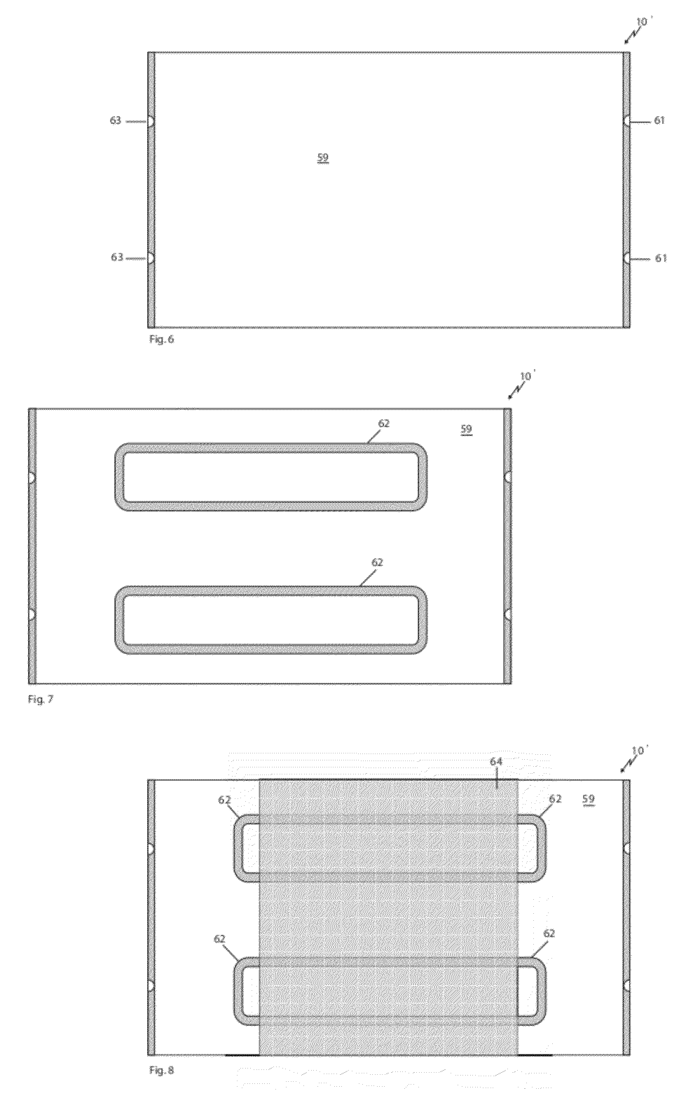

FIGS. 6-13 show still another embodiment, wherein the bag 10′ is first formed by die cutting the material 59, laying in drawstring 63, folding, and fusing both ends to form a drawstring closure. Strips 62 of plastic are then positioned in a loop to form handles in the center of each bag, visible in FIG. 7. As can be seen in FIG. 8, a top sheet 64 is then placed over the first (bottom) sheet 59 to form a double layer of film. The two layers may be fused thereby sandwiching and securing a portion of the handle strips 62 between the two layers.

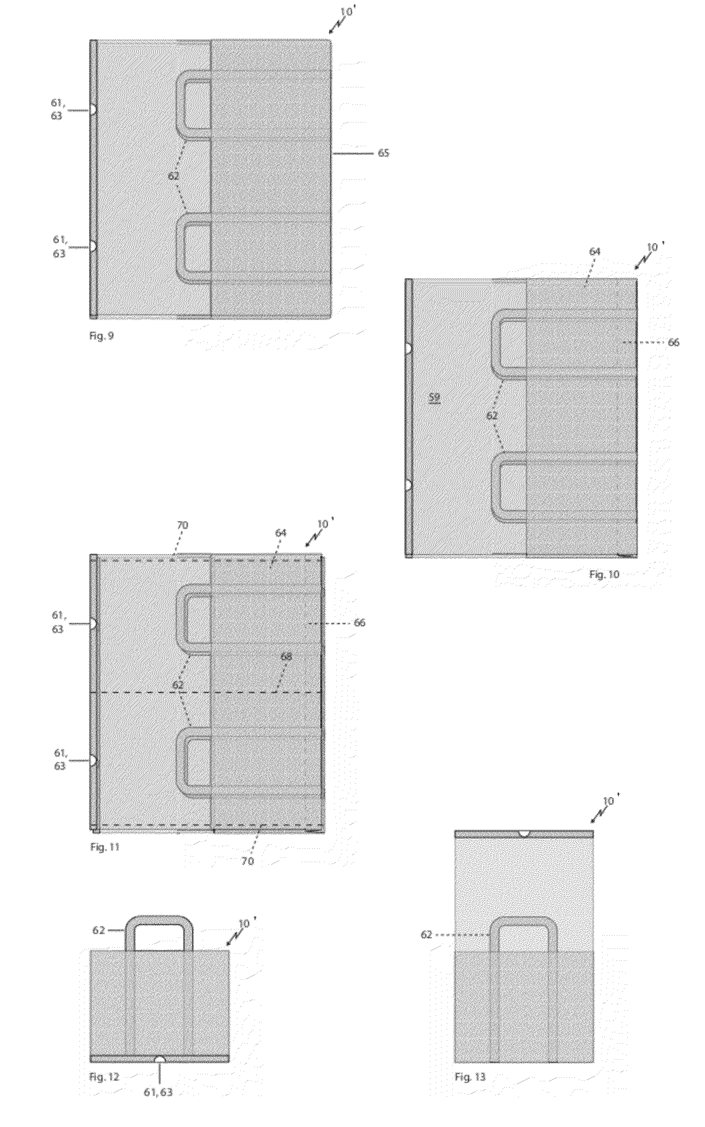

FIG. 9 shows the layers of FIG. 8 folded in half, aligning the handles 62 and drawstrings 61, 63 of both sides together. A bottom edge 65 may then be folded in between top and bottom sheets 64, 59, so as to form a gusset 66, visible in FIGS. 10 and 11. Finally, the folded layers may be cut where indicated by dotted line 68, and sealed where indicated by dotted lines 70, visible in FIG. 11.

Once again, this embodiment can be used in at least two different forms: as a shopping/storage bag 10′, shown in FIG. 12, or as a receptacle bag 10′, shown in FIG. 13.

It should be understood that while the description herein discusses either cutting or heat fusing various edges of the bags 10, 10′, other types of cutting and fusing of materials is contemplated. For example, sonic fusion, glue, laser cutting and fusion, and other types of technology may be used to create the seams, edges, and joining portions of bag 10, 10′.

While the disclosure is susceptible to various modifications and alternative forms, specific exemplary embodiments thereof have been shown by way of example in the drawings and have herein been described in detail. It should be understood, however, that there is not intent to limit the disclosure to the particular embodiments disclosed, but on the contrary, the intention is to cover all modifications, equivalents, and alternatives falling within the spirit and scope of the disclosure as defined by the appended claims.

What is claimed is:

1. An apparatus for carrying items, the apparatus comprising
a plastic bag configured to be interchangeably used as a shopping bag and a garbage receptacle,
wherein when the plastic bag is used as a shopping bag, a top section of the bag is folded over a bottom, multi-layered section of the bag to expose handles,
and wherein when the plastic bag is used as a receptacle, the top section is unfolded away from the bottom section to expose a receptacle bag that is longer than the shopping bag.

2. The apparatus of claim 1, further comprising a drawstring positioned at the top of the top section of the plastic bag.

3. The apparatus of claim 1, wherein the handles are reinforced two-ply or multi-ply sections.

4. The apparatus of claim 1, wherein the handles are positioned inside the plastic bag when the plastic bag is configured as a receptacle.

5. The apparatus of claim 1, wherein the top section of the plastic bag comprises a single layer of plastic.

6. The apparatus of claim 5, wherein the bottom, multi-layered section of the plastic bag includes a layer of plastic that extends beyond the bottom section to become the single-layered top section.

7. The apparatus of claim 1, further comprising information printed on the sides of the bag.

8. The apparatus of claim 1, wherein the bottom of the bag comprises a gusset.

9. The apparatus of claim 1, wherein the plastic bag is configured to be linked to and stored with additional, identical plastic bags.

10. A method of producing a plastic bag configurable as a shopping bag or a garbage can liner, the method comprising
providing a first sheet of plastic,
folding over a portion of one end of the first sheet of plastic and fusing the folded-over portion,
forming a hole in the folded-over section to provide a handle and handle end,
folding approximately two-thirds of the sheet over the handle end,
fusing at least a portion of the perimeter of the overlay,
forming and folding a second sheet in a manner identical to the first sheet of plastic,
placing the second sheet of plastic in registry with the first sheet of plastic such that the handles of both pieces of plastic are facing each other, and
fusing the lateral sides and bottom of the first and second sheets of plastic.

11. The method of claim 10, wherein the method further comprises forming a gusset by folding part of the bottoms of each of the two stacked sheets in between the sheets before fusing the lateral sides.

12. The method of claim 10, wherein the method further comprises cutting a hole in the first sheet near a second end opposite the handle end, laying a drawstring along the second end and across the hole, folding the second end over the drawstring, and fusing the edge of the folded portion to enclose the drawstring.

13. The method of claim 10, wherein the first sheet is the width of multiple bags, and the fused first and second sheets are cut lengthwise multiple times to form a plurality of bags capable of being bundled together in multiples.

14. The method of claim 13, wherein a segment of the sides of each of the plurality of bags is left uncut, resulting in the bags being linked together.

15. The method of claim 10, further comprising the step of printing information on the bags.

16. An apparatus for carrying items, the apparatus comprising
a bag configured to be interchangeably used as a shopping bag and a receptacle,
wherein when the bag is used as a shopping bag, a top section of the bag is folded over a bottom section of the bag to expose handles,
and wherein when the bag is used as a receptacle, the top section is lifted away from the bottom section to expose a receptacle having a drawstring positioned at the top of the receptacle.

17. The apparatus of claim 16, further comprising a second bag attached to the bag, the second bag being formed with the first bag such that it is not completely separated from the first bag.

18. The apparatus of claim 16, wherein the bottom section of the bag comprises a double layer of material.

19. The apparatus of claim 16, wherein the top section of the bag comprises a single layer of material.
